(19) United States
(12) Patent Application Publication
(10) Pub. No.: US 2014/0022776 A1
(43) Pub. Date: Jan. 23, 2014

(54) LAMP HOLDER FIXTURE

(71) Applicants: JUSTING TECHNOLOGY PTE. LTD., Singapore (SG); JUSTING TECHNOLOGY(TAIWAN) PTE LTD., Zhongli City (TW)

(72) Inventors: CHIA- CHING SU, ZHONGLI CITY (TW); CHIH-YUAN YEN, ZHONGLI CITY (TW)

(21) Appl. No.: 13/937,333

(22) Filed: Jul. 9, 2013

(30) Foreign Application Priority Data
Jul. 19, 2012 (TW) 101213942

(51) Int. Cl. F21V 19/00

(52) U.S. Cl. CPC F21V 19/008
USPC 362/218; 362/217.14; 362/217.02

(57) ABSTRACT

A lamp holder fixture is disclosed. The lamp holders of the present invention are positioned respectively at one tail end of a lamp tube by the fixtures. At least a through-hole is disposed near a tail end of the lamp tube, the lamp holder is formed with a positioning hole corresponding to the through-hole, and the fixture is provided with two elastic arms and an abut portion that connects the two elastic arms. A tail end of the elastic arm is formed with a latch portion and the latch portion is transfixed into the through-hole and the positioning hole orderly to sheath the lamp holder at the lamp tube, so that the lamp holder can be positioned quickly.

### BACKGROUND OF THE INVENTION

a) Field of the Invention

The present invention relates to a lamp holder fixture, and more particularly to a lamp holder fixture which improves a fixing effect to the lamp holder and increases convenience in fixing the lamp holder.

b) Description of the Prior Art

An early fluorescent lamp tube is mostly made of glass and contains small amount of mercury. Therefore, one should be very careful when taking or installing the fluorescent lamp tube; if the fluorescent lamp tube is broken accidentally, the mercury will flow out and damage the environment. In addition, if a person touches or adsorbs the mercury by accident, then he or she may be poisoned. On the other hand, although a conventional fluorescent lamp is cheaper, its wastes can result in mercury pollution or the fluorescent lamp can be fragile.

For a new generation of the fluorescent lamp, an LED (Light Emitting Diode) is used to give out light, but the structure is still the same as the early design of the fluorescent lamp, so as to be used in an early lamp bracket.

Referring to FIG. 1, an ordinary LED light tube is assembled from a lamp housing 11, an LED element 12 and two plugs 13, wherein the lamp housing 11 is a tubular structure formed by latching a long strip of housing base 14 with a long strip of diffuser 15. Furthermore, the lamp housing 11 is provided with a holding space 18 to emplace a substrate 17 of the LED element 12 and the plugs 13 are fixed respectively at one end of the housing base 14 with screws 19. Nevertheless, it requires a tool to dismantle or lock the LED light tube if the screws 19 are used for fixing.

### SUMMARY OF THE INVENTION

Accordingly, the primary object of the present invention is to provide a lamp holder fixture to improve a fixing effect to the lamp holder and to increase convenience in fixing the lamp holder.

To achieve the abovementioned object, the lamp holders are positioned respectively at one tail end of a lamp tube by the fixtures, wherein at least a through-hole is disposed near a tail end of the lamp tube and the lamp holder is formed with a positioning hole corresponding to the through-hole; whereas, the fixture is provided with two elastic arms and an abut portion that connects the two elastic arms, with that a latch portion is formed at a tail end of the elastic arm.

The latch portion is transfixed into the through-hole and the positioning hole orderly to sheath the lamp holder at the lamp tube, thereby improving the fixing effect to the lamp holder and increasing the convenience in fixing the lamp holder.

By the abovementioned primary characteristics of structures, the said lamp tube is provided primarily with a housing base, a diffuser and a light source module. The housing base is a structure with a roughly semi-circular cross section and an interior of the housing base, opposite to the semi-circle, is formed with a holding space in a shape of a saddle. A bottom of the holding space is provided with a fixing portion and each through-hole is located above the fixing portion. The diffuser is covered with an opening of the holding space of the housing base; whereas, the light source module is provided with a circuit board and plural light emitting elements disposed on the circuit board. In addition, the circuit board can be positioned on the fixing portion of the housing base by the abut portion.

By the abovementioned primary characteristics of structures, heat conductive adhesive can be added between the fixing portion and the circuit board of the said housing base.

By the abovementioned primary characteristics of structures, the said lamp holder is provided with two electric terminals and an interior side of the lamp holder is provided with a conductive terminal. The conductive terminal and the electric terminals are connected together, and two ends of the circuit board of the light source module are provided respectively with one connecting seat. The connecting seat is provided with a casing and the casing is provided at least with a slot. An interior of the slot is provided with a terminal and a conductive sheet that is connected with the terminal. The conductive sheet is also extended to a side of the casing to connect the circuit board electrically; whereas, each slot provides for insertion with the conductive terminal of the lamp holder to form conduction.

By the abovementioned primary characteristics of structures, an exterior side of the said housing base, opposite to the semi-circle, is provided with plural cooling fins.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of a conventional lamp holder and lamp tube.

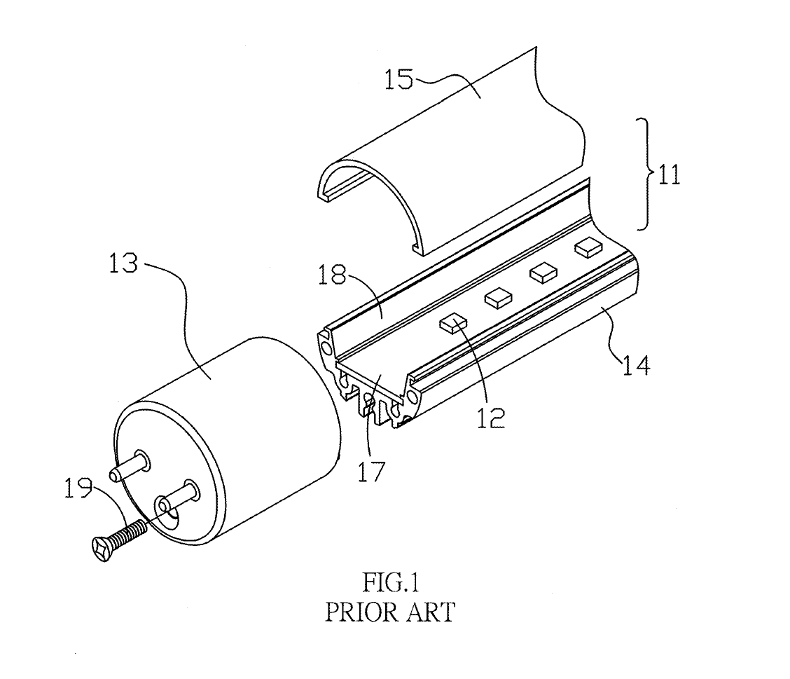

FIG. 2 shows a three-dimensional view of a lamp holder and a lamp tube, according to the present invention.

FIG. 3 shows an exploded view of the lamp holder and the lamp tube, according to the present invention.

FIG. 4 shows a three-dimensional view of a fixture and a circuit board, according to the present invention.

### DETAILED DESCRIPTION OF THE PREFERRED EMBODIMENTS

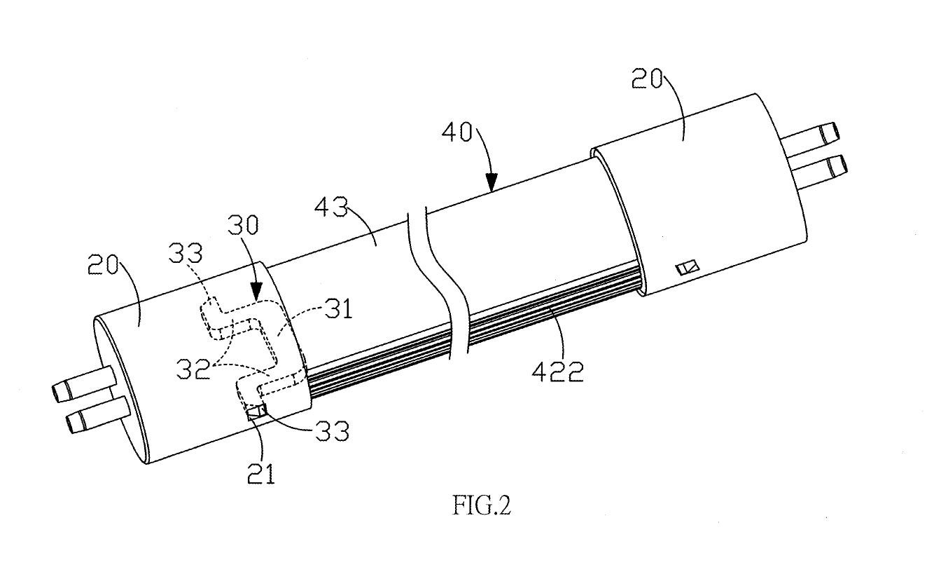

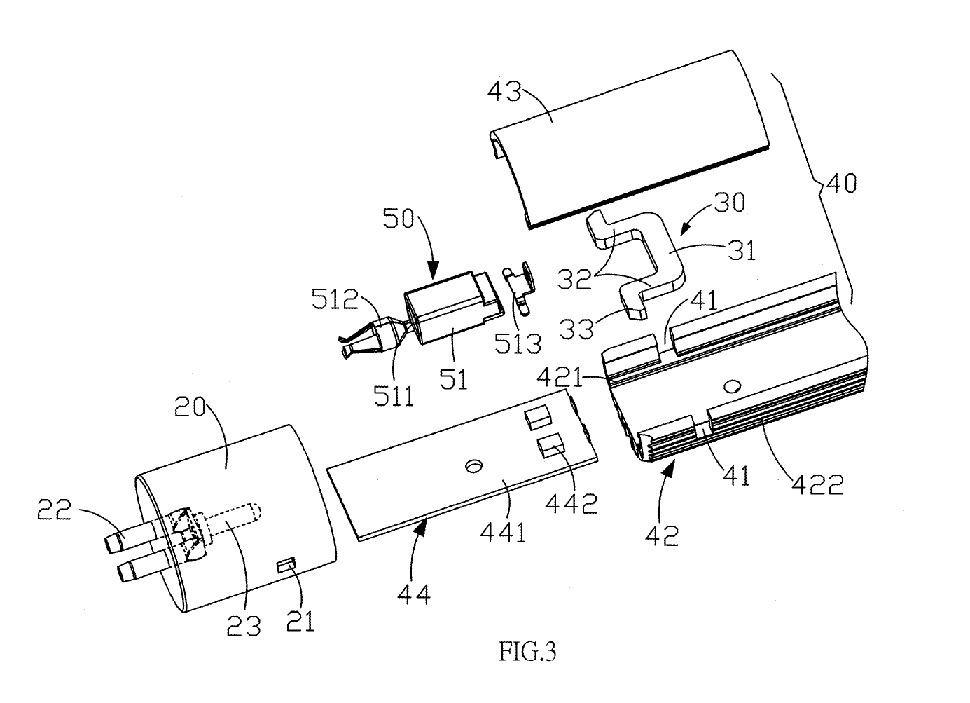

FIG. 2 discloses a three-dimensional view of a lamp holder and a lamp tube, according to the present invention; whereas, FIG. 3 discloses an exploded view of the lamp holder and the lamp tube, according to the present invention. The lamp holders 20 of the present invention are positioned respectively at one tail end of the lamp tube 40 by the fixtures 30. The lamp tube 40 is provided at least with a through-hole 41 near a tail end, and the lamp holder 20 is provided with a positioning hole 21 corresponding to the through-hole 41. The fixture 30 is provided with two elastic arms 31 and an abut portion 32 that connects the two elastic arms 31; whereas, a tail end of the elastic arm 31 is formed with a latch portion 33.

Upon assembling, the latch portion 33 is transfixed into the through-hole 41 and the positioning hole 21 orderly to sheath the lamp holder 20 at the lamp tube 40, thereby improving a fixing effect to the lamp holder 20 and increasing convenience in fixing the lamp holder 20. When the lamp holder 20 is to be dismantled from the lamp tube 40, the latch portion 33 only needs to be pressed inward to release from the positioning hole 21 that the lamp holder 20 can be separated from the lamp tube 40.

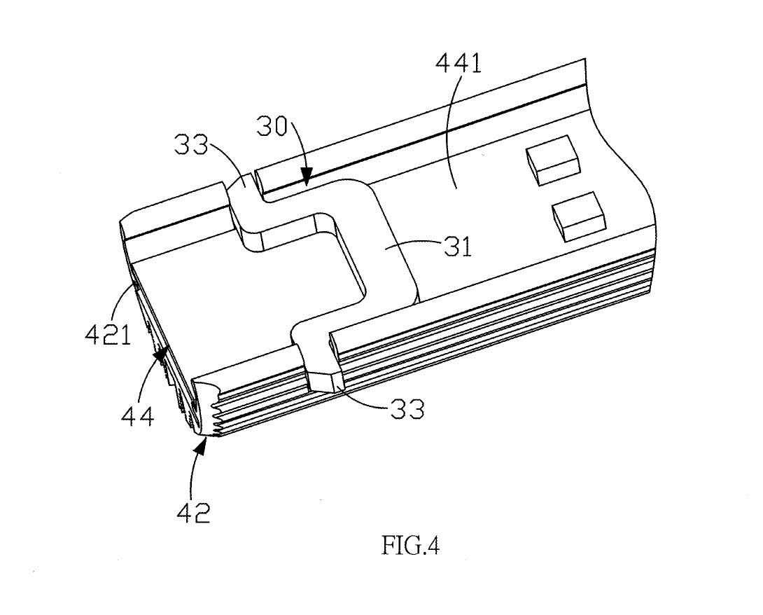

Moreover, the lamp tube 40 includes primarily a housing base 42, a diffuser 43 and a light source module 44. The housing base 42 is a structure with a roughly semi-circular cross section, and an interior of the housing base 42, opposite to the semi-circle, is formed with a holding space in a shape of a saddle. A bottom of the holding space is provided with a fixing portion 421, and each through-hole 41 is located above the fixing portion 421. In addition, an exterior of the housing base 42, opposite to the semi-circle, is provided with plural cooling fins 422; whereas, the diffuser 43 is covered with an opening of the holding space of the housing base 42. The light source module 44 is provided with a circuit board 441 and plural light emitting elements 442 disposed on the circuit board 441. Referring to FIG. 4, the circuit board 441 can be positioned on the fixing portion 421 of the housing base 42 by the abut portion 32, in order to improve a conventional way of locking a circuit board with screws, thereby increasing flexibility of assembling the light source module 44 and improving a fixing effect to the light source module 44. In addition, heat conductive adhesive can be added between the fixing portion 421 and the circuit board 441 of the housing base 42 to further increase the fixing effect.

Furthermore, the lamp holder 20 is provided with two electric terminals 22 and an interior side of the lamp holder 20 is provided with a conductive terminal 23. The conductive terminal 23 and the electric terminals 22 are formed integrally and connected together. Two ends of the circuit board 441 of the light source module 44 are provided respectively with one connecting seat 50. The connecting seat 50 is provided with a casing 51, and the casing 51 is provided at least with a slot 511. An interior of the slot 511 is provided with a terminal 512 and a conductive sheet 513 that is connected with the terminal 512. The conductive sheet 513 is also extended to a side of the casing 51 to connect the circuit board 441 electrically; whereas, the slot 511 provides for insertion with the conductive terminal 23 of the lamp holder 20 to form conduction. When the lamp tube of the present invention is inserted into a conventional lamp holder, the electric terminals 22 and the conductive terminal 23 will form a current loop by the connecting seat 50 and the circuit board 441, allowing the light emitting element 442 to illuminate by receiving electricity. Accordingly, a simple insertion operation can be utilized to assemble the lamp holder with the lamp tube, so that the lamp can be assembled, repaired and tested easily, and parts thereof can be replaced easily, thereby increasing practicability.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lamp holder fixture, the lamp holders being positioned respectively at one tail end of a lamp tube by the fixtures, wherein
a through-hole is disposed near a tail end of the lamp tube, the lamp holder is formed with a positioning hole corresponding to the through-hole, the fixture is provided with two elastic arms and an abut portion connecting the two elastic arms, a tail end of the elastic arm is formed with a latch portion and the latch portion is transfixed into the through-hole and the positioning hole orderly to sheath the lamp holder at the lamp tube.

2. The lamp holder fixture according to claim 1, wherein the lamp tube comprises:
a housing base, the housing base is a structure with a roughly semi-circular cross section and an interior of the housing base, opposite to the semi-circle, is formed with a holding space in a shape of a saddle, with that a bottom of the holding space is provided with a fixing portion and each through-hole is located above the fixing portion;
a diffuser, the diffuser is covered with an opening of the holding space of the housing base; and
a light source module, the light source module is provided with a circuit board and plural light emitting elements disposed on the circuit board, with that the circuit board is positioned on the fixing portion of the housing base by the abut portion.

3. The lamp holder fixture according to claim 2, wherein heat conductive adhesive is added between the fixing portion and the circuit board of the housing base.

4. The lamp holder fixture according to claim 2, wherein an exterior of the housing base, opposite to the semi-circle, is provided with plural cooling fins.

5. The lamp holder fixture according to claim 2, wherein the lamp holder is provided with two electric terminals, an interior side of the lamp holder is provided with a conductive terminal, the conductive terminal is connected with the electric terminals, two ends of the circuit board of the light source module are provided respectively with one connecting seat, the connecting seat is provided with a casing, the casing is provided with a slot, an interior of the slot is provided with a terminal and a conductive sheet that is connected with the terminal, the conductive sheet is extended to a side of the casing to connect the circuit board electrically, and the slot provides for insertion with the conductive terminal of the lamp holder to form conduction.

6. The lamp holder fixture according to claim 3, wherein the lamp holder is provided with two electric terminals, an interior side of the lamp holder is provided with a conductive terminal, the conductive terminal is connected with the electric terminals, two ends of the circuit board of the light source module are provided respectively with one connecting seat, the connecting seat is provided with a casing, the casing is provided with a slot, an interior of the slot is provided with a terminal and a conductive sheet that is connected with the terminal, the conductive sheet is extended to a side of the casing to connect the circuit board electrically, and the slot provides for insertion with the conductive terminal of the lamp holder to form conduction.

7. The lamp holder fixture according to claim 4, wherein the lamp holder is provided with two electric terminals, an interior side of the lamp holder is provided with a conductive terminal, the conductive terminal is connected with the electric terminals, two ends of the circuit board of the light source module are provided respectively with one connecting seat, the connecting seat is provided with a casing, the casing is provided with a slot, an interior of the slot is provided with a terminal and a conductive sheet that is connected with the terminal, the conductive sheet is extended to a side of the casing to connect the circuit board electrically, and the slot provides for insertion with the conductive terminal of the lamp holder to form conduction.
